(19) United States
(12) Patent Application Publication
(10) Pub. No.: US 2011/0276410 A1
(43) Pub. Date: Nov. 10, 2011

(54) Apparatus and Method for Advertising during Login Process

(75) Inventors: Johan Hjelm, Tokyo (JP); Mattias Lidström, Stockholm (SE); Mona Matti, Nacka (SE)

(73) Assignee: TELEFONAKTIEBOLAGET LM ERICSSON (PUBL), Stockholm (SE)

(21) Appl. No.: 13/144,802

(22) PCT Filed: Jan. 16, 2009
(86) PCT No.: PCT/JP2009/051026

§ 371 Date: Jul. 15, 2011

(51) Int. Cl. G06Q 30/00

(52) U.S. Cl. 705/14.66

(57) ABSTRACT

An apparatus for presenting a personalized advertisement in a login process for logging into a certain service by a user of a user terminal is provided. The apparatus includes a recognition unit configured to recognize the user terminal under the login process, an obtaining unit configured to obtain a user identity of the user using the recognized user terminal and an advertising unit configured to present to the recognized user terminal a personalized advertisement associated with the obtained user identity when the user identity is obtained by the obtaining unit. The advertising unit presents the personalized advertisement to the recognized user terminal before the user is authenticated.

### TECHNICAL FIELD

The present invention relates to an apparatus and method for advertising during login process.

### BACKGROUND

A network architecture called “IP Multimedia Subsystem” (IMS) has been developed by the 3rd Generation Partnership Project (3GPP) as an open standard for handling multimedia services and sessions in the packet domain (for details regarding the IMS, please refer to http://www.3gpp.org/ftp/Specs/html-info/22173.htm). Various communication terminals and devices (hereinafter referred to as IMS terminals) that conform to the IMS standard are now known. A typical example of an IMS terminal is a mobile phone with IMS functionality. A personal computer (PC), a personal digital assistant (PDA), or the like can also serve as IMS terminals if they are equipped with IMS functionality. IMS terminals can provide multimedia services by, for example, receiving video streaming from a video-streaming server over an IMS network.

International Publication No. WO 2006/045706 discloses a multimedia gateway called an “IG (IP Multimedia Subsystem (IMS) Gateway)”, which enables non-IMS terminals without IMS functionality, such as a desktop PC and a laptop PC, to access services via the IMS network. The IG is located in a private network, to which at least one user terminal is connected. The IG can be implemented on a “Set Top Box” (STB), a “Residential Gateway” (RGW), or different home devices.

In many systems, users are required to log in to use the services provided. At a conventional login process, the user is usually presented a system-generated login screen, containing fields where the user is required to provide username and password. This is typically realized by verifying the credentials against a database, which can be situated locally in the device, or centrally in a server.

The login screen is typically not relevant to the available services, and presents the username and password fields on a neutral background. This is a wasted opportunity, which could be further explored by the system described in this document.

Korean Patent Laid-Open No. 2001-0100331 proposes a technique for advertising during login process. According to the technique, an advertisement connected to an advertising site is displayed on the web browser of a user, while the user is moving into a web site selected by the user. However, the advertisements are presented to the user only after the user is authenticated.

Korean Patent Laid-Open No. 2006-0037157 also proposes a technique for advertising during login process. According to the technique, a user is required a secondary password based on advertisement information which is being displayed. However, the advertisements are presented to the user only after the user inputs the primary password.

Therefore, it is desired to provide another technique for enhancing effect of advertisements during login process.

### SUMMARY

According to a first aspect of the invention, an apparatus for presenting a personalized advertisement in a login process for logging into a certain service by a user of a user terminal is provided. The apparatus includes a recognition unit configured to recognize the user terminal under the login process, an obtaining unit configured to obtain a user identity of the user using the recognized user terminal, and an advertising unit configured to present to the recognized user terminal a personalized advertisement associated with the obtained user identity when the user identity is obtained by the obtaining unit. The advertising unit presents the personalized advertisement to the recognized user terminal before the user is authenticated.

According to a second aspect of the invention, an advertising system is provided. The system includes a user terminal, a gateway server, and an advertising server. The user terminal is used by a user to log in a certain service. The gateway server presents a personalized advertisement in a login process for logging in by a user of the user terminal and includes a recognition unit configured to recognize the user terminal under the login process, an obtaining unit configured to obtain a user identity of the user using the recognized user terminal, and an advertising unit configured to present to the recognized user terminal a personalized advertisement associated with the obtained user identity when the user identity is obtained by the obtaining unit. The advertising server provides advertisements to the gateway server based on the user identity. The advertising unit is configured to present the personalized advertisement to the recognized user terminal before the user is authenticated.

Further features of the present invention will become apparent from the following description of exemplary embodiments with reference to the attached drawings.

### BRIEF DESCRIPTION OF DRAWINGS

FIG. 1 shows an exemplary advertising system 10 according to one embodiment of the present invention.

FIG. 2A shows an exemplary gateway apparatus 100 according to the embodiment of the present invention.

FIG. 2B shows an exemplary user terminal 110 according to the embodiment of the present invention.

FIG. 3 shows an exemplary login screen according to the embodiment of the present invention.

FIG. 4 shows an exemplary login screen according to the embodiment of the present invention.

FIG. 5 shows an exemplary login screen according to the embodiment of the present invention.

FIG. 6 shows an exemplary login screen according to the embodiment of the present invention.

FIGS. 7A and 7B show an exemplary sequence diagram describing how the gateway apparatus 100 presents advertisements to the user terminal 110, according to one aspect of the present invention.

FIG. 8 shows an exemplary advertisement table according to the embodiment of the present invention.

FIG. 9 shows an exemplary log table according to the embodiment of the present invention.

### DETAILED DESCRIPTION

Embodiments of the present invention will now be described with reference to the attached drawings. Each embodiment described below will be helpful in understanding a variety of concepts from the generic to the more specific.

It should be noted that the technical scope of the present invention is defined by claims, and is not limited by each embodiment described below. In addition, not all combinations of the features described in the embodiments are always indispensable for the present invention.

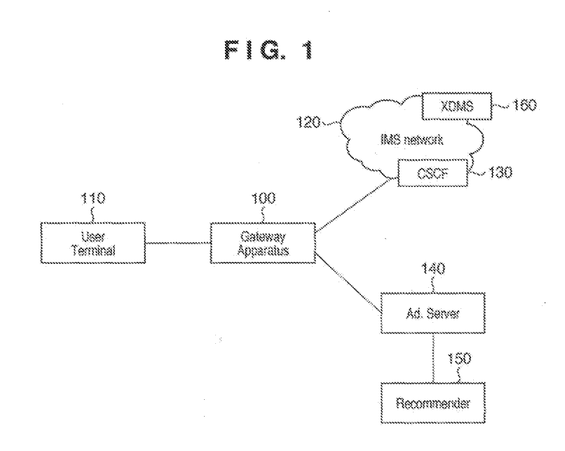

FIG. 1 shows an exemplary advertising system 10 according to one embodiment of the present invention. The advertising system 10 includes a gateway apparatus 100, a user terminal 110, an IMS network 120, an advertising server 140, a recommender 150, and a XDMS (XML Data Management Service) 160.

The user terminal 110 is used by its user who desires to use services provided in the IMS network 120. The user terminal 110 accesses the gateway apparatus 100 and is presented with a login screen. The gateway apparatus 100 forwards the request from the user terminal 110 to the CSCF 130 in the IMS network 120. The advertising server 140 provides advertisements to the gateway apparatus 100. The recommender 150 provides recommendations to the advertising server 140. The XDMS 160 stores user profiles to be used in advertising.

The user terminal 110 may be a general-purpose computer, such as a desktop or laptop computer, a personal digital assistance (PDA), a smart phone, a mobile terminal, or an IPTV. The CSCF 130 may include a Proxy CSCF (P-CSCF), an Interrogating CSCF (I-CSCF), and a Serving CSCF (S-CSCF), etc.

The gateway apparatus 100 may be implemented in the AG module of the IMS gateway (IG), which can be realized in the IG with an associated Application Gateway (AG) module. The IMS gateway is a gateway between the IMS network 120 and DLNA network. In this case, the user terminal 110 in the DLNA network accesses the IMS network 120 only via the IMS gateway. The IMS gateway is used for the authentication and authorization of the user in the IMS-based IPTV system, in particular. It is assumed to perform the translation between the HTTP- or UPNP-based signaling in the local area network and the SIP-based IMS signaling in the wide area network. The “IG with AG” is also assumed to contain a web server by default. It is also assumed to contain an IMS User Agent (UA), which is presented towards the IMS system. These components are the normal components of the IG.

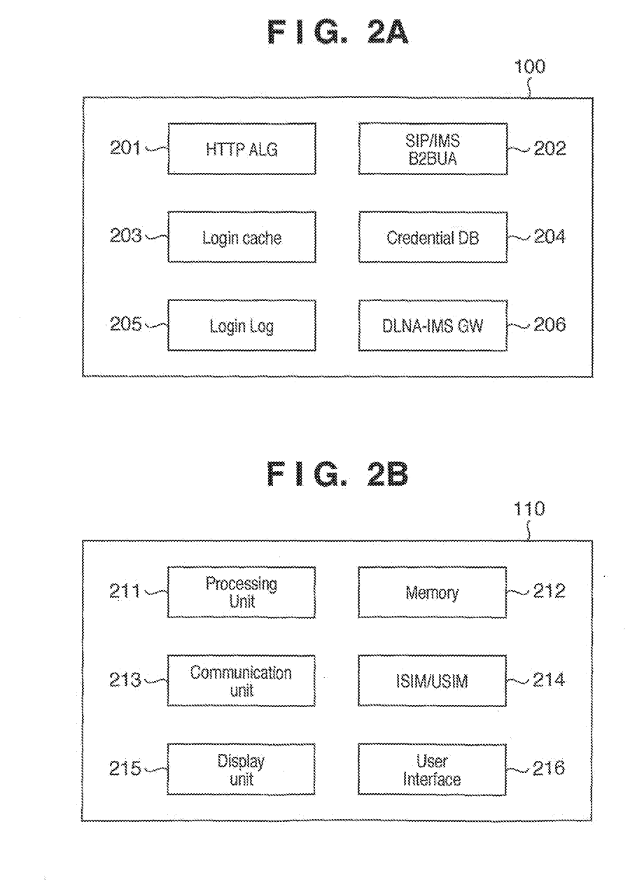

FIG. 2A shows an exemplary gateway apparatus 100 according to the embodiment of the present invention. The gateway apparatus 100 includes a HTTP ALG 201, a SIP/IMS B2BUA (Back to Back User Agent) 202, a login cache 203, a credential database (DB) 204, a login log 205, and a DLNA-IMS gateway (GW) 206.

The HTTP ALG 201 serves as an interface for the user terminal 110. For example, the HTTP ALG 201 presents a login screen to the user terminal 110. The SIP/IMS B2BUS 202 performs the conversion between IETF SIP and IMS SIP so that a terminal connected to the gateway apparatus 100 is not IMS-enabled can access the IMS network 120. The login cache 203 is used to construct the login screen from the credentials input forms and the background image(s). The login cache 203, combined with a log of the advertisements that have been presented to the user, can be used as a shared secret between the user and the system 10. The credential database 204 verifies a credential and an answer from the user terminal 110. The login log 205 stores advertisements presented to the user associated with the user identity. The DLNA-IMS gateway 206 translates a DLNA request to an IMS session setup when the user terminal 110 is a DLNA terminal.

Both the SIP/IMS B2BUA 202, the login cache 203, the credential database 204, the login log 205, and the DLNA-IMS gateway 206 may be implemented as modules in the HTTP ALG 201; or the HTTP ALG 201 together with the other functions could be implemented as modules in a system (in principle a HTTP proxy with added functionality), for instance an OSGI (Open Service gateway Initiative) system.

FIG. 2B shows an exemplary user terminal 110 according to the embodiment of the present invention. The user terminal 110 includes a processing unit 211, a memory 212, a communication unit 213, an ISIM/USIM 214, a display unit 215, and a user interface 216.

The processing unit 211 executes processing necessary for controlling the user terminal 110. The memory 212 stores computer program to be executed by the processing unit 211. The communication unit 213 transmits and receives information from/to other apparatus, such as the gateway apparatus 100. The ISIM/USIM 214 stores essential information to work as an IMS terminal, such as shared secret for the authentication and IP Multimedia Public Identity (IMPU). The ISIM/USIN 214 is predefined for the user terminal 110 and is used for recognition of the user terminal 110. The display unit 215 displays information for the user of the user terminal 110. The user interface 216 is an interface for the user to input instruction, including a mouse and a keyboard for example.

In FIGS. 2A and 2B, each module may be implemented as an independent hardware module which executing corresponding processing program to achieve desired functions, or a software module including corresponding process codes executed in a processor, such as CPU, MPU, VGA, FPGA, ASIC, or DSP.

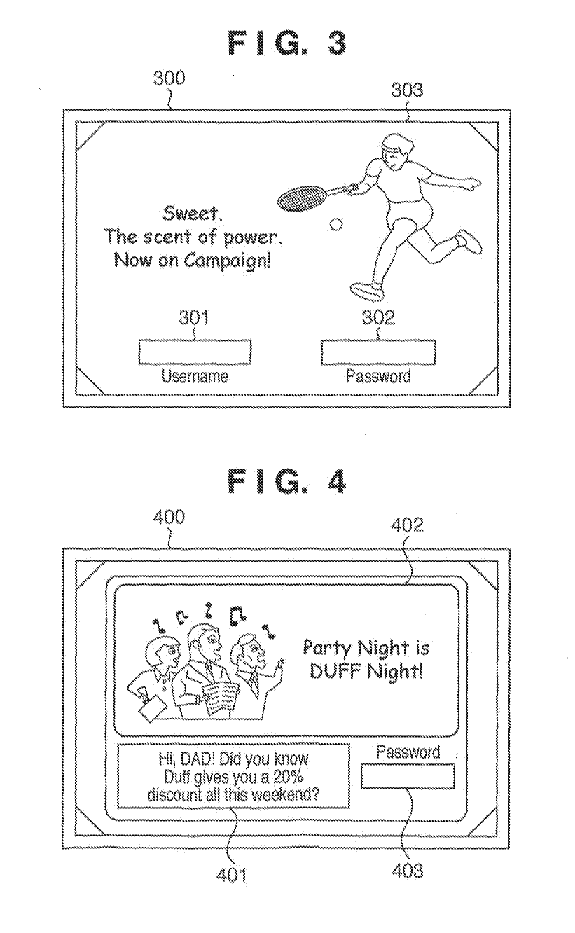

Outlines of some exemplary embodiments are described with reference to FIGS. 3 through 6. FIG. 3 shows an exemplary login screen according to the embodiment of the present invention. Assume that a user whose username is “DAD” desires to log into a certain service using his/her user terminal 110. When the user terminal 110 requests for the service, the gateway apparatus 100 returns a login screen 300 in FIG. 3 to the user terminal 110. The login screen 300 includes a username entry field 301 and a password entry field 302. The login screen 300 also includes an advertisement 303 as the background image of the login screen 300. This advertisement 303 is not personalized yet. In other wards, the advertisement 303 is designed to target unspecified persons using the user terminal 110. The non-personalized advertisement 303 may be presented on to the user terminal 110 during the whole login process.

After the user inputs his/her username as a user identity to the username entry field 301, the gateway apparatus 100 updates the login screen 400 such as one described in FIG. 4. FIG. 4 shows an exemplary login screen according to the embodiment of the present invention. In the updated login screen 400, an advertisement 402 is presented for the user. This advertisement 402 is personalized for the user. The gateway apparatus 100 presents the personalized advertisement 402 based on the obtained user identity, for example the username. The personalized advertisement 402 is associated with the user. The user is still encouraged to input own password into the password entry field 403.

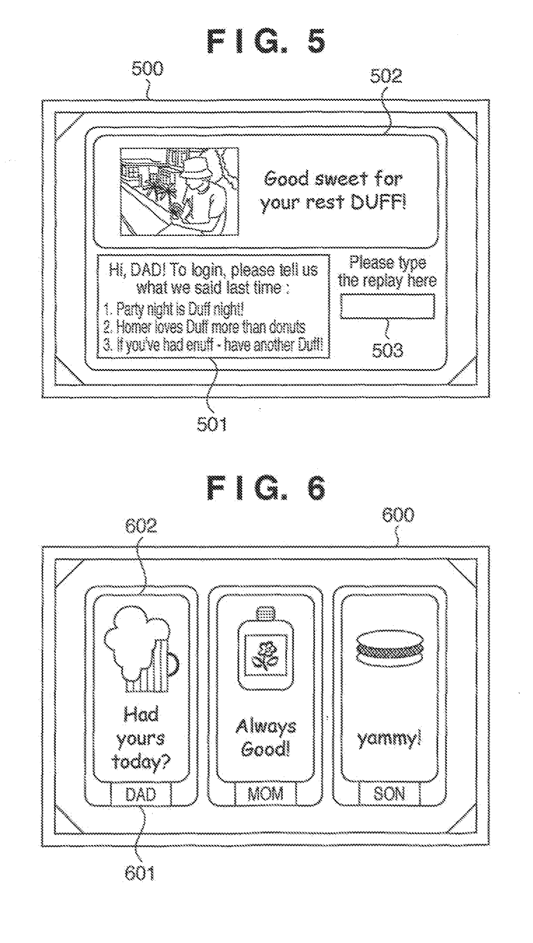

The user may input own password. When the password is correct, the gateway apparatus 100 further updates the login screen 500 such as described in FIG. 5. FIG. 5 shows an exemplary login screen according to the embodiment of the present invention. In the updated login screen 500, an advertisement 502 is presented for the user. This advertisement 502 is dedicated for the user. That is, the advertisement 502 is designed to target only the person currently using the user terminal 110.

The login screen 500 also includes a question 501 and an answer field 503. The question 501 is based on the personalized advertisement 401 that is presented to the user in previous screen in the same login process. To be delivered the service, the user should input the answer into the answer field 603. Therefore, the user should pay attention to the personalized advertisement 401, which enhances the advertising effect. When the input answer is correct, the user is allowed access to the desired service.

The question 501 may be based on the personalized advertisement 401 or the dedicated advertisement 502 presented at previous login processes. To do so, the user is encouraged to login very frequently, or the user would forget the advertisement. Hereinafter, the question based on advertisements presented to the user previously is referred to as a “captcha.”

In some cases, more than one user belonging to a group may log into a certain service with their group identity. As is described, the group identity is an identity that includes one or more user identities corresponding to persons constituting the group. One form of group identity is a family identity that includes, for example, three user identities for “DAD”, “MOM”, and “SON.” The family may log into the IPTV service. In this case, a personalized advertisement cannot be presented since the gateway apparatus 100 cannot determine which user of the group identity is using the user terminal 110. Therefore, after a user of the group selects one of the user identities, the login screen 300 is presented.

However, the gateway apparatus 100 may present personalized advertisements for each of the users included in the group simultaneously such as described in FIG. 6. FIG. 6 shows an exemplary login screen according to the embodiment of the present invention. The login screen 600 includes user selection icons 601 corresponding to the user identities included the group identity. The users included in the group can input own user identity by pressing the user selection icon 601. When the user “DAD” presses his user selection icon, the login screen 600 changes to the login screen 400 in FIG. 4.

The user selection icon 601 may include a personalized advertisement for each of the users described in FIG. 6. These advertisements 602, as well as those used in FIG. 4, need to be filtered based on the user profile and the time of the day for suitability to be viewed by all users of the group, since no authentication has taken place yet and hence there is no way to know that the authorized user is actually viewing the advertisements 602.

The login can be performed for the group as a whole, and might then be constrained to providing only the password. It is also possible that the group identity is automatically logged in, and it is only when individual users wish to log in that the system is activated.

In FIG. 4, the gateway apparatus 100 may present a message 401 on the login screen 400 to the user in addition to the personalized advertisement 402. This message 401 may be a remainder registered by the user or another user previously. For example, the father could have a message which he put in, saying “remember the game on Friday!” or another user could put in messages for other family members, e.g. the mother could put in a message saying “wedding day in 3 weeks, start planning!” for the father. The messages may include broadcast notifications, as standardized in various standardization forums (e.g. Open IPTV Forum).

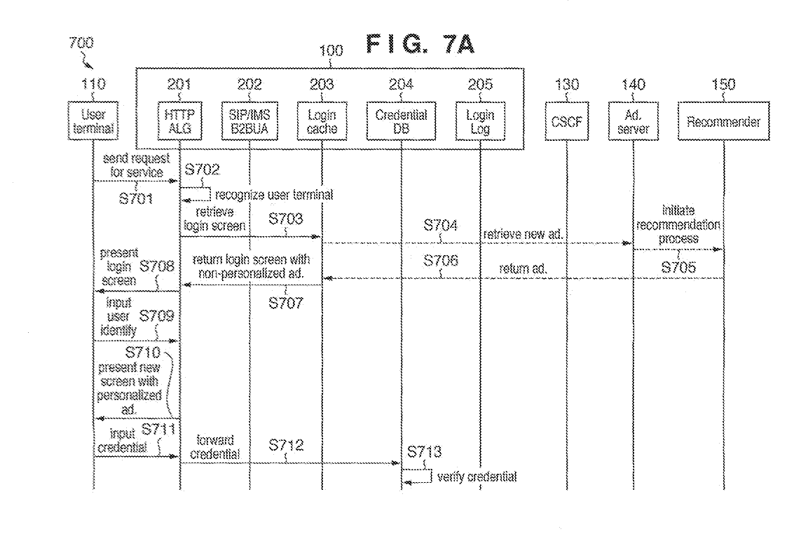

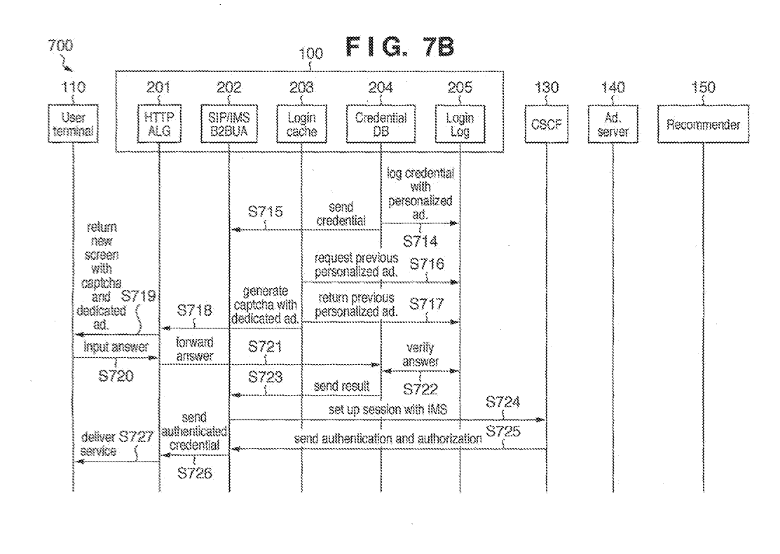

Now a detailed process 700 is described with reference to FIGS. 7A and 7B. FIGS. 7A and 7B show an exemplary sequence diagram describing how the gateway apparatus 100 presents advertisements to the user terminal 110, according to one aspect of the present invention.

In step S701, the user terminal 110 sends a request for a certain service to the HTTP ALG 201, when the request is using HTTP as its main communications protocol. The HTTP ALG 201 intercepts the request for service. When the request is using UPnP, the request may be sent to the DLNA-IMS gateway 206 which will translate the request to an IMS session setup. The HTTP ALG 201 will not be used in that case, but the DLNA-IMS gateway 206 plays the role that the HTTP ALG 201 plays in the following description. When the request is using SIP, the SIP-IMS B2BUA 202 may play the role taken by the HTTP ALG 201 in the following description. Alternatively, when the user terminal 110 is a DLNA terminal, a DLNA request is sent to the DLNA-IMS gateway 206. This will fulfill the same function in this description.

In Step S702, the HTTP ALG 201 recognizes the user terminal 110 requested the service using the ISIM/USIM 214 included in the user terminal 110. When the user terminal 110 is an IMS terminal, the HTTP ALG 201 may use its IP Multimedia Public Identity (IPMU) to recognize the user terminal 110. In Step S703, the HTTP ALG 201 retrieves the login screen associated with the user terminal 110 from the login cache 203.

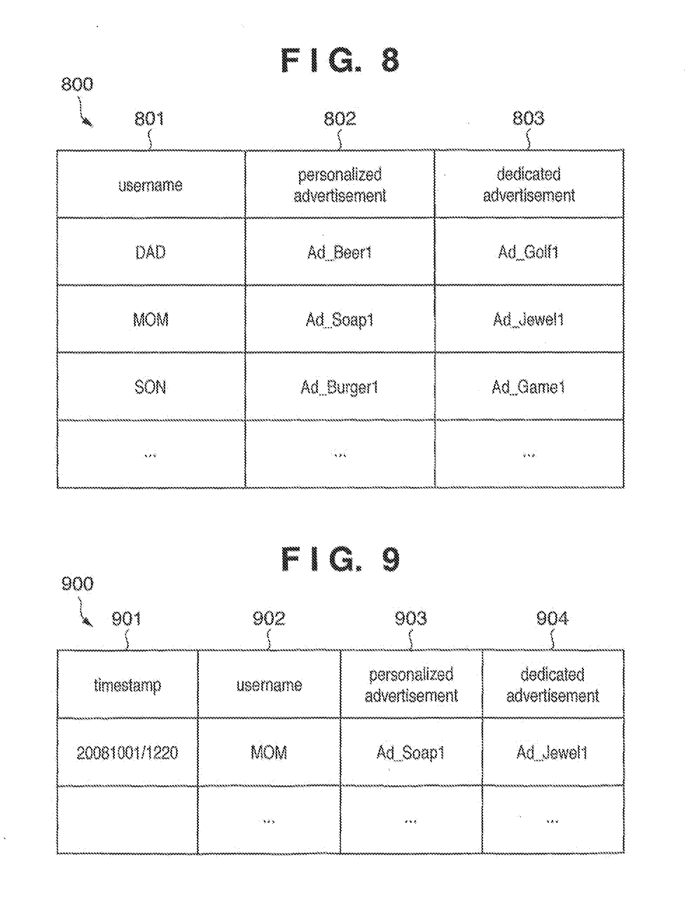

The login cache 203 includes an advertisement table 800 in FIG. 8. FIG. 8 shows an exemplary advertisement table according to the embodiment of the present invention. The items of the advertisement table 800 include a username 801, a personalized advertisement 802, and a dedicated advertisement 803. The personalized advertisement 802 and the dedicated advertisement 803 are associated with the username 801. For example, the personalized advertisement 802 for the username 801 “MOM” is “Ad_Soapl” which is designed to target middle-aged women. The dedicated advertisement 803 for the username 801 “SON” is “Ad_Game1” which is designed to target young boys. The dedicated advertisement 803 may be an advertisement that “SON” does not want other family members to see. Of course, the personalized advertisement 802 and dedicated advertisement 803 may include more than one advertisement.

In Step S704, the login cache 203 may retrieve new advertisements from the advertising server 140. In Step S705, the advertising server 140 may contact the recommender 150 of the requested service, where recommendation process will be initiated and will be based on the previously presented login screen to the user terminal 110, which is used to derive a recommendation for the current login screen. In Step S706, the recommender 150 returns advertisements to the login cache 203 via the advertising server 140.

Steps S704 through S706 are optional steps and can be populated in an out-of-band process, which may occur at any time. When these steps are populated, retrieved advertisements, together with their metadata, will be retained by the login cache 203 to construct further screens. The new advertisements may be presented to the users as non-personalized advertisements 303, personalized advertisements 402 and 602, or dedicated advertisements 502.

In Step S707, the login cache 203 returns the login screen with non-personalized advertisements to the HTTP ALG 201. In Step S708, the HTTP ALG 201 presents the Login screen to the user terminal 110 that has requested the service. The user of the user terminal 110 inputs own user identity and credential via the login screen. The user identity may be a username, handle name, nickname, or the like, or any combinations of thereof. The credential may be a password, a passcode, a passphrase, a biometric recognition, an identification by presenting a physical token, a voice recognition, or the like, or any combinations of thereof. The login screen also includes non-personalized advertisements 303. The login screens can be in a form of HTML pages, or rendered from a CSS style sheet, and XML page, or some other page description and rendering control language. It is also possible to send programs that can be executed to present the username and password request fields. The login screen 300 may also include animations, such as video images with sound.

In Step S709, the user of the user terminal 110 inputs his/her user identity into the presented login screen 300 and the user terminal 110 sends the user identity to the HTTP ALG 201. In Step S710, the HTTP ALG 201 updates the login screen to present personalized advertisements 402 associated with the obtained user identity. The personalized advertisements 402 may be stored by the login cache 203. In addition to the personalized advertisements, the HTTP ALG 201 may also present messages to the user having the obtained user identity as mentioned above. Therefore, the personalized advertisement associated with the user is presented before the user is authenticated.

In Step S711, the user of the user terminal 110 inputs own credential via the presented login screen 400 and the user terminal 110 sends the credential to the HTTP ALG 201.

In Step S712, the HTTP ALG 201 forwards the credential to the credential database 204, which checks the credential input against entries in the database. In parallel to Step S712, the HTTP ALG 201 may forward the user identity to the advertising server 140 via the login cache 203, to bind the initiated recommendation to the persistent User ID (in an IMS system, the IMPU).

In Step S713, the credential database 204 verifies the credential and may optionally return its local authentication to the HTTP ALG. That would in effect enable the user to use local resources after this step. After verification, in Step S714, the credential database 204 logs the login, including the personalized advertisement, in the login log 205. The login log 205 stores the personalized advertisement associating with the user identity. The login log 205 includes a login table 900 in FIG. 9. FIG. 9 shows an exemplary login table according to the embodiment of the present invention. The items of the advertisement table 900 include a timestamp 901, a username 902, a personalized advertisement 903, and a dedicated advertisement 904. The timestamp 901 stores the date and time when the user terminal 110 accesses the gateway apparatus 100 and the username 902 stores the username of the user terminal 110. The personalized advertisement 903 and the dedicated advertisement 904 are the advertisements that are presented to the user at the login process.

In Step S715, the credential database 204 sends a request for session setup, which includes an authentication request, to the SIP/IMS B2BUA 202. In Step S715, the credential database 204 triggers the login cache 203 to generate a captcha 501 and the login cache 203 requests previous advertisements (with metadata if applicable) from the login log 205. In Step S716, the login log 205 returns stored advertisements (with metadata if applicable).

In Step S718, the login cache 203 generates the captcha based on the returned advertisements and sends the captcha to the HTTP ALG 201. The captcha may be based on advertiser preferences depending on the recommendation received from the recommender 150 based on the login user knowledge extracted from the machine learning methods used in the knowledge discovery/extracting system (not shown).

In Step S719, the HTTP ALG 201 updates the login screen to present the captcha to the user. The HTTP ALG 201 may present a dedicated advertisement associated with the user identity to the user terminal 110 and store the dedicated advertisement associating with the user identity in the login log 205.

In Step S720, the user inputs an answer for the captcha and the user terminal 110 sends the answer to the HTTP ALG 201. In Step S721, the HTTP ALG 201 forwards the answer to the credential database 204. In Step S722, the credential database 204 determined whether the answer is correct, according to the stored advertisement in the login log 205. When the answer is correct, the credential database 204 returns a clearance to the HTTP ALG 201. On the other hand, when the answer is not correct, the login process fails. Alternately, the HTTP ALG 201 may present the advertisement and the captcha again for the user to answer the question easily.

In Step S724, the SIP/IMS B2BUA 202 sets up session with IMS network 120 through the CSCF 130. This step can be performed according to either of two alternatives. When the service requested is activated using IMS, the IMS session is set up with the SIP/IMS B2BUA 202, and the service activated. When the service requested is activated using HTTP, the HTTP ALG 201 can receive the authentication, and send a separate service activation request.

In Step S725, the CSCF 130 authenticates the user, authorizes the service and sends the authentication and authorization to the SIP/IMS B2BUA 202. In Step S726, the SIP/IMS B2BUA 202 sends the authentication to the HTTP ALG 201. After that, the HTTP ALG 201 requests the service. The service initiates a knowledge extraction request to the Knowledge Extraction System to find out the recommendation based on the profile and the social networks of the user. The service retrieves the User Profile from the XDMS 160, which implies getting information about the users preferences etc. In addition, the service may retrieve the presence information of the user, which would give it access to the users social network information. If the user can be persistently identified, for instance using a cookie or session identifier, there can be synchronization between the advertisements inserted in the service and the advertisements inserted in the login screen.

The service retrieves advertisements based on the recommendations based on the knowledge discovered about the user profile, user social networks, etc. A personalized service is delivered depending on the recommendations it has received and with dedicated advertisements to the HTTP ALG 201 or the DLNA-IMS gateway 206, which forwards it to the User terminal 110. In Step S727, the service is delivered to the user.

Some exemplary modifications are described below. In Step S718, the login cache 203 may generate the captcha, controlled by the remote advertising server 140 through the metadata which accompanies the advertisements, and which could be changed depending on the current situation and campaigns that the advertiser of the advertisements may be running.

The assumption is that accompanying the advertisement, there is metadata that will enable the login cache 203 to generate the login screen according to the preferences of the advertiser. The metadata can be embedded in the advertising file, or linked to it. The metadata may consist of for instance instructions on how to compose the file depending on current campaigns, giving priority to items that the advertiser wishes to highlight, preference for items pertaining to current season, and questions in the captcha that the advertiser believes can promote the product.

For instance, in summer, questions that lead the user to think about light, fruity drinks that quench thirst may be prioritized, while in winter, the stress may be on warming up the frozen hands of the user by pouring a steaming cup of drink. The metadata may consist of an XML and CSS template from which questions can be composed automatically, or of text embedded in formatting instructions, or something similar.

The login cache 203 may query the advertising server 140 for advertisements that are relevant to the present login process, using the recommendations that were initiated in Step S705 in FIG. 7A. Since the user has presented own user identity, the user profile of the user can be applied to the users interactions with the system. This implies that the users previous logins can be used to guide the process of advertising selection, as well as the relation of the user identity to other user identities (e.g. through group memberships and the use of recommendations).

When the advertising server 140 receives the query, the advertising server 140 does two things. At the first, the advertising server 140 contacts the Campaign Server (not shown) to find out what metadata should be applied. This may be done as meta-metadata, that is, the advertising server 140 (or even the login cache 203) does not receive the actual metadata, only the rules used to generate the metadata. At the second, the advertising server 140 contacts the recommender 150 to find out what advertisements are most applicable for this user identity. The recommender 150 may check the users group affiliations in the Presence and Availability Group Management system. The recommender 150 was initiated already in Step S705 in FIG. 7A. The group may include at least one of a demographic, social, or economic group. The term demographic refers to selected population characteristics as used in government, marketing, or opinion research.

The advertising server 140 may receive the recommendations from the recommender 150 and the campaign server, and composes the metadata that relates to the current question. The advertising server 140 then sends the metadata, together with the advertisements, to the login cache 203.

The login cache 203 may include a login screen with advertising and selected queries according to the metadata (if rules are provided, these can be used to generate the screen; or there is a default set of rules which are used to generate the page). The metadata may contain formatting rules as well as rules for which questions and other information that should be selected for querying the user, as mentioned in the preamble.

The metadata can be downloaded with the advertisements in Step S704 in FIG. 7A. The metadata can include descriptions, but also rules and template information for how to create a captcha from the previously viewed advertisement. This is particularly applicable in case a randomly selected advertisement from the last few logins is used, instead of the absolute latest. The captcha question could then relate to the shared secret between the system 10 and the user, for instance “when did you see this advertisement when you logged in?” The user will respond with a date.

In addition to the metadata, the system 10 can leverage user-provided rules. The rules can include filters that determine what information can be provided to an advertiser. There are, of course, security considerations as well as privacy considerations. The system 10 can be used together with the Generic Bootstrapping Architecture (GBA), for instance. In that case, it should be possible to trigger the creation of the authentication vector by using the described mechanism to exchange secrets; or it may even be possible to replace or enhance the ISIM-based shared secret exchange by a preliminary step, based on the described method.

The present invention provides a personalized advertisement based on the user identity to the user during login process. This provides the user with a more interesting experience during the login process. Further, the user may be required to answer the question about the presented advertisement, which encourages the user to pay more attention to the advertisement. Thus, advertising effect is enhanced.

While the present invention has' been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1-16. (canceled)

17. An apparatus for presenting a personalized advertisement to a user of a user terminal during a login process for logging the user into a certain service, comprising:
a recognition unit configured to recognize the user terminal being used for the login process;
an obtaining unit configured to obtain a user identity of the user using the recognized user terminal; and
an advertising unit configured to present to the recognized user terminal a personalized advertisement associated with the obtained user identity, wherein the advertising unit presents the personalized advertisement before the user is authenticated by the login process.

18. The apparatus of claim 17, further comprising
a storage unit configured to store the personalized advertisement associated with the user identity, and
a question presentation unit configured to generate a question based on the stored personalized advertisement and to present the question to the recognized user terminal when the user identity is obtained by the obtaining unit,
wherein the obtaining unit is configured to obtain an answer to the presented question from the recognized user terminal, and
wherein the user is successfully authenticated when the answer is correct.

19. The apparatus of claim 17, wherein
said obtaining unit is configured to obtain a group identity before obtaining the user identity of said user logging into the service, wherein the group identity identifies a group to which said user belongs and is associated with user identities of users included in that group, and
the advertising unit is configured to simultaneously present on a login screen personalized advertisements associated with the user identifies of users included in the group, until the obtaining unit obtains the user identity of said user.

20. The apparatus of claim 19, wherein the login screen includes user selection icons for selecting a user to be logged into the service, wherein the obtaining unit is configured to obtain the user identity of the user corresponding to a selected user selection icon, and wherein the advertising unit is configured to present a personalized advertisement associated with the obtained user identity that corresponds to the selected user selection icon.

21. The apparatus of claim 20, wherein the advertising unit is configured to simultaneously present personalized advertisements associated with the user identifies of users included in the group, by presenting those personalized advertisements on corresponding ones of the user selection icons.

22. The apparatus of claim 17, wherein the advertising unit is further configured to present to the recognized user terminal a non-personalized advertisement before or during presentation of the personalized advertisement, wherein the non-personalized advertisement is designed to target unspecified persons.

23. The apparatus of claim 17, wherein the advertising unit is further configured to present to the recognized user terminal a dedicated advertisement associated with the user identity after the user identity is successfully authenticated, wherein the dedicated advertisement is designed to target only the person associated with the user identity.

24. The apparatus of claim 17, wherein the advertising unit is further configured to present a message previously registered by said user of the recognized user terminal, or by another user of the recognized user terminal, in addition to the personalized advertisement.

25. The apparatus of claim 17, wherein the user is authenticated using at least one of a password, a passcode, a passphrase, a biometric recognition, an identification by presenting a physical token, or a voice recognition.

26. The apparatus of claim 17, wherein
the user terminal is a DLNA terminal,
the apparatus is an IP Multimedia Subsystem (IMS) gateway server between a DLNA network and an IMS network,
the IMS network provides the certain service for the user, and
the DLNA network includes the user terminal and the user terminal accesses the IMS network only via the IMS gateway server.

27. The apparatus of claim 17, wherein the user terminal is an IMS terminal, and the recognition unit is configured to recognize the user terminal using an IP Multimedia Public Identity that is predefined for the IMS terminal.

28. An advertising system comprising:
a user terminal configured to be used by a user to log into a certain service;
a gateway server for presenting a personalized advertisement to the user of the user terminal during a login process for logging the user into the certain service, comprising:
a recognition unit configured to recognize the user terminal being used for the login process;
an obtaining unit configured to obtain a user identity of the user using the recognized user terminal; and
an advertising unit configured to present to the recognized user terminal a personalized advertisement associated with the obtained user identity, wherein the advertising unit presents the personalized advertisement before the user is authenticated by the login process; and
an advertising server configured to provide advertisements to the gateway server based on the user identity.

29. The system of claim 28, wherein the advertising server provides the advertisements based on preferences of an advertiser associated with those advertisements, wherein the preferences includes at least one of a preference for current campaigns, a preference for items which the advertiser wishes to highlight, and a preference for items pertaining to a current season.

30. The system of claim 28, wherein the advertising server provides the advertisements based on preferences of a group to which the user belongs, the group including at least one of a demographic, social, or economic group.

31. A method for presenting a personalized advertisement to a user of a user terminal during a login process for logging the user into a certain service, comprising:
recognizing the user terminal being used for the login process;
obtaining a user identity of the user using the recognized user terminal; and
after the user identity is obtained but before the user is authenticated by the login process, presenting to the recognized user terminal a personalized advertisement associated with the obtained user identity.

32. The method of claim 31, further comprising:
storing the personalized advertisement associated with the user identity,
generating a question based on the stored personalized advertisement;
presenting the question to the recognized user terminal when the user identity is obtained;
obtaining an answer to the presented question from the recognized user terminal, and
successfully authenticating the user if the answer is correct.

33. The method of claim 31, further comprising:
obtaining a group identity before obtaining a user identity of said user logging into the service, wherein the group identity identifies a group to which said user belongs and is associated with user identities of users included in that group, and
simultaneously presenting on a login screen personalized advertisements associated with the user identifies of users included in the group, until the user identity of said user is obtained.

34. The method of claim 33, wherein the login screen includes user selection icons for selecting a user to be logged into the service, wherein said obtaining comprises obtaining the user identity of the user corresponding to a selected user selection icon, and wherein said presenting comprises presenting a personalized advertisement associated with the obtained user identity that corresponds to the selected user selection icon.

35. The method of claim 34, wherein said simultaneous presenting comprises simultaneously presenting personalized advertisements associated with the user identifies of users included in the group, by presenting those personalized advertisements on corresponding ones of the user selection icons.

36. A computer program product stored on a computer-readable medium and comprising computer program instructions that, when executed by a processor associated with an apparatus, cause the apparatus to present a personalized advertisement to a user of a user terminal during a login process for logging the user into a certain service, wherein the computer program instructions cause the apparatus to:
recognize the user terminal being used for the login process;
obtain a user identity of the user using the recognized user terminal; and
before the user is authenticated by the login process, present to the recognized user terminal a personalized advertisement associated with the obtained user identity.
